(19) United States
(12) Patent Application Publication
(10) Pub. No.: US 2006/0040218 A1
(43) Pub. Date: Feb. 23, 2006

(54) Terpene ether solvents

(76) Inventors: Marion F. Wyatt, Jacksonville, FL (US); R. Scott Gallagher, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 10/920,951

(22) Filed: Aug. 18, 2004

(51) Int. Cl. G03C 5/44

(52) U.S. Cl. 430/431

(57) ABSTRACT

Disclosed is a photopolymer developing solution that includes at least one terpene ether. The terpene ether can contain a methyl and/or ethyl ether and be monocyclic. The terpene ether may be based on an orange flower ether having a pleasant odor. The terpene ether has a flash point above 140° F. and a relatively low vapor pressure. The photopolymer developing solution may further include a co-solvent and/or a non-solvent. Typically, the co-solvent is benzyl alcohol.

### FIELD OF THE INVENTION

The present invention relates to the development of flexographic (photopolymer) printing plates, and more specifically to a developer solvent comprising a terpene ether.

### BACKGROUND

Flexography, or flexographic printing, is a type of relief printing that uses flexible sheets (plates) of photopolymer to transfer an image onto a substrate. These photopolymer printing plates, sometimes called flexographic or “flexo” plates, are light sensitive. When a flexo plate is exposed to light, the exposed areas cross-link and become insoluble in organic solvents. The unexposed portions of the plate remain soluble, and can be removed or “washed-out” by a variety of organic solvent blends. The process of removing the soluble unexposed portions of the plate with a solvent is commonly referred to as “developing” the plate. The organic solvent blend used to washout the plate is commonly referred to as the “developer solvent”.

When a photopolymer plate is developed, even the portions of the plate that were exposed to light absorb some of the developer solvent. This results in “swelling”, wherein the thickness of the plate increases. Swelling is an unwanted side-effect of developing, as the thickness of the developed plate must be within close tolerances to the original plate thickness, or the original image will not be reproduced accurately on press.

Because plates absorb solvent and swell during the developing step, they must be “dried” in an oven for a period of time to return the plates to their original thickness. A developed flexo plate is considered “dry” when it has returned to its original thickness (its original thickness before developing). The resulting developed and dried plate will contain a raised (relief) image in those areas where light passed through the negative in the exposure step, making those portions of the photopolymer insoluble in the developer solvent. Once the plate is exposed, developed, and dried, it is wrapped around a cylinder on a printing press, and used to print the desired image onto a substrate such as paper, film, foil, etc.

All flexographic developer solvents will evaporate from the photopolymer plate during the drying process. However, certain solvent compositions swell the plates more severely than others, and dry slower than others. All things being equal, a flexographic developer solvent that swells plates less and dries faster is preferred, because the plates can be used sooner, and therefore a flexo plate processing facility can process more plates in a given period of time. A developer solvent that causes severe swelling and/or slow drying results in longer processing time and reduced throughput. It is the desire of the flexo printing industry to use solvents that permit the fastest possible plate production rates.

There are other factors that contribute to the value of a flexographic developer solvent. For example, solvent-soaked plates are handled by people, developer solvents that present an objectionable odor are less desirable. Workers strongly prefer a solvent with a mild odor. For the same reason, solvents that have low toxicity or are naturally-derived are more desirable.

Because waste solvents are reprocessed, solvents that are considered non-hazardous by RCRA guidelines are preferred. Developer solvents with a flash point above 140° F. are normally classified as non-hazardous, therefore high flash point solvents are preferred. Additionally, since solvents are reprocessed by distillation, solvents that are easy to distill are preferred.

Furthermore, plate development (washout) time can sometimes be lengthy, solvents that develop plates quickly are more desirable and since so many types of flexo plates available, it is important that the developer solvent be capable of developing all of the various plates on the market.

Example solvent blends for developing photopolymer plates are disclosed in U.S. Pat. Nos. 6,162,593 (2000) and 6,682,877 (2004) to Wyatt et al. The disclosed solvents contain diisopropylbenzene, a solvent that is nearly odorless with a high flash point. Unfortunately, use of this solvent can cause excessive plate swelling resulting in long dry times. U.S. Pat. No. 6,582,886 (2003) to Hendrickson et al. discloses solvents containing methyl esters; while these solvents have low odor intensity and do not excessively swell plates, they develop plates very slowly, resulting in longer processing times, and can be difficult to reclaim by distillation. U.S. Pat. No. 6,291,141 (2001) to Bovati et al. discloses solvents based on alicyclic hydrocarbons, aromatic hydrocarbons, and aliphatic alcohols; these solvents can result in excessive swelling and long dry times.

U.S. Pat. No. 6,248,502 (2001) to Eklund discloses solvents based on terpene esters; while these solvents have high flash points, they also have slow developing speed and are difficult to reprocess by distillation. U.S. Pat. Nos. 5,578,420 (1996) and 5,521,054 (1996) to Takagi et al. disclose solvents based on aromatic hydrocarbons; these solvents also cause excessive swelling and long drying times. U.S. Pat. No. 5,354,645 (1994) to Schober et al. discloses solvents based on glycol ethers; these solvents have very long development times on most modern flexo plates, and are impractical to use for that reason. U.S. Pat. No. 5,312,719 (1994) to Schlosser et al. discloses solvents based on aromatic hydrocarbons; these solvents (like the other solvents based on aromatic hydrocarbons) cause excessive swelling and long drying times. U.S. Pat. Nos. 5,116,720 (1992) and 5,077,177 (1991) to Frass et al. discloses solvents based on phenol ethers; phenol ethers have extremely strong odors, and are therefore not practical to use in commercial flexo processing facilities. U.S. Pat. No. 5,061,606 (1991) to Telser discloses solvents based on hydro treated petroleum fractions; while these solvents do not have strong odors, they (like most hydrocarbons) do cause excessive plate swelling and longer drying times.

U.S. Pat. No. 4,847,182 (1989) to Worns et al. discloses solvents based on terpene hydrocarbons; like other solvents based on hydrocarbons, they cause excessive swelling and long drying times, and terpene hydrocarbons have strong odors and low flash points. U.S. Pat. No. 4,806,452 (1989) to Hoffmann et al. discloses solvents based on d-limonene; like other solvents containing monoterpenes, these solvents excessively swell plates and have strong odors and low flash points. U.S. Pat. No. 4,271,261 (1981) to Shimizu et al. discloses solvents based on glycol ethers and acids; like other solvents based on glycol ethers, their development time is excessive on most modern flexo plates which makes them impractical. U.S. Pat. No. 4,267,260 (1981) to Miura et al. discloses solvents based on glycol ethers; like other glycol ether solvents, these solvents do not develop all plates at an acceptable rate and are impractical.

Thus, what is needed is a solvent with a low odor intensity that does not cause excessive swelling of the plates during development and that has a flash point above 140° F. Furthermore, it would be advantageous to have a solvent that has a low toxicity or is environmentally friendly. Additionally, a solvent that is easy to distill or reclaim and one that does not require multiple solvents to develop the plates would be advantageous.

### SUMMARY

The present invention includes a solvent for developing photopolymer printing plates. The developer solvent comprises a blend of terpene ethers alone, or in combination with one or more co-solvents and/or non-solvents. The terpene ethers effectively develop most all commercial solvent-processed photopolymer plates, while minimizing odor, plate swell, dry time, toxicological problems, and regulatory problems.

The solvent containing terpene ethers is essentially nontoxic and has relatively low odor intensity, swells plates less, and dries quickly when compared to most conventional solvents. The solvent is suitable for use in all conventional plate processing equipment with virtually all commercially available solvent-processed plates and can be reclaimed in all conventional distillation reprocessing equipment.

Disclosed is a photopolymer developing solution that includes at least one terpene ether. The terpene ether can contain a methyl and/or ethyl ether and be monocyclic. The terpene ether may be based on an orange flower ether having a pleasant odor. The terpene ether has a flash point above 140° F. and relatively low vapor pressure. The photopolymer developing solution may further include a co-solvent and/or a non-solvent. Typically, the co-solvent is benzyl alcohol. The non-solvent-may be a mineral oil.

Additionally, a method is provided for developing photopolymer printing plates. The method includes washing an exposed photopolymer printing plate with a developing solution including at least one terpene ether and then drying the photopolymer printing plate. The method further includes exposing the backside of the photopolymer printing plate to a radiation source for cross-linking a polymer and exposing the topside of the photopolymer printing plate to the radiation source through a negative mask to produce the exposed photopolymer printing plate. Typically, the radiation source is a UV lamp.

### DETAILED DESCRIPTION

The present invention relates to the use of terpene ethers as a solvent for use in photopolymer printing plate processing. Terpene ethers, can be used either alone or in combination with other solvents and non-solvents as a solvent for use in the photopolymer printing plate process. Terpene ether based solvents can be used to develop a wide array of different photopolymer printing plates.

Terpene ethers are naturally occurring plant extracts typically used as fragrance ingredients by perfumers. They can be extracted from plants and flowers, or can be manufactured synthetically from other plant extracts. Terpene ethers have low-toxicity, and are safe for cosmetic as well as industrial uses. For example orange flower ether (CAS# 14576-08-0), a naturally occurring chemical with a sweet and mild flavor, a tart, limey fragrance, has excellent solubility for non-cross-linked photopolymer. P-cymenyl methyl ether, which naturally occurs in the oil of black pepper, has a very low odor, and similarly excellent solubility for non-cross-linked photopolymer. All of the methyl and ethyl ethers of acyclic, monocyclic, and bicyclic monoterpenes exhibit low or pleasant odors, are non-toxic and naturally occurring, and have similar solubility for non-cross-linked photopolymer. FIG. 1 shows the chemical structures of selected terpene ethers, and are representative of the present invention:

[image]

A number of other solvents can be mixed with terpene ethers to enhance performance, alter physical properties, or reduce cost. The suitable co-solvents include alcohols, hydrocarbons and other similar solvents and non-solvents (diluents). These co-solvents and non-solvents can be used to assist in the development of conventional photopolymer plates, but are not always necessary (for instance in the development of pre-masked digital photopolymer plates).

Ideally, the co-solvents and non-solvents should be miscible with terpene ethers, have suitable solubility parameters, have suitable toxicity and safety profiles, be readily disposable, and have pleasant odors. These co-solvents and non-solvents are used to modify the properties of the solvent blend. This includes the addition of solvents to aid in the removal of the cover layer of certain flexographic plates (benzyl alcohol, for example), improve the odor of the blend (limonene, for example), and/or make the reclamation of the solvent by distillation easier (mineral oil, for example).

These terpene ether-based developer solvents may be substituted for any of the developer solvents described in the prior art including petroleum distillates, synthetic hydrocarbons, terpene hydrocarbons, glycol ethers, other oxygenated solvents (alcohols, esters, ketones), aromatic hydrocarbons, or halogenated hydrocarbon solvents presently used for processing photopolymer printing plates. Terpene ether-based solvents can be applied to the plates by any conventional application means including spraying, brushing, rolling, dipping (immersing) or any combination thereof.

The terpene ether-based solvents produce photopolymer plates with less swelling and distortion than those processed with terpene hydrocarbons, terpene esters, aromatic hydrocarbons, or chlorinated hydrocarbon solvents. This reduction in swelling and distortion is surprising because while other aggressive flexographic developer solvents (such as hydrocarbon solvents) may quickly remove the unexposed polymer in the development process, they also aggressively attack the exposed cross-linked polymer resulting in plate swelling, distortion of the image, and much longer drying times when compared to the terpene ether-based solvents. Flexographic solvents of the prior art have not exhibited this degree of selectivity for non-cross-linked polymer vs. cross-linked polymer, and thus swell plates more severely during processing, and therefore require a longer time to dry before use.

In the following examples, (7) different developer solvents were tested under identical conditions to compare the wash time, swell rate, and dry time during processing. The composition of the solvents is listed in Table 1.

### EXAMPLE 1

A commercially available flexographic printing plate (0.067″ AFP® HD, mfg. by Asahi) was first back-exposed using a UV light source in a commercial flexo plate exposure unit to form the cross-linked polymer floor of the printing plate. The top of the plate was exposed to the same UV light source through a negative mask to define the relief (image) areas. The exposed plate was then developed by immersion with rotary brushing in a mixture of 50 wt % orange flower ether (CAS# 14576-08-0), and 50 wt % benzyl alcohol in the developer section of the Platemaker at a temperature of 25° C. The development process was continued until the plate floor was reached. The time required to develop the plate to the floor is the “Wash Time” as reported in Table 2. The exposed plate thickness was measured after washout, and this data is reported as “Final Plate Thickness” in Table 2. The difference between initial thickness and final thickness is the “Plate Swell” as reported also in Table 2. The developed plate was then dried at 140° F. in a commercial flexo plate drying unit until it returned to its original thickness (0.067″), which is an indication that all absorbed solvent has been removed and the plate is dry. The time required to dry the plate is the “Dry Time” as reported in Table 2.

As can be seen from the data, the developer solvent based on methyl ethers of monocyclic terpenes exhibited minimal swelling and fast dry time.

### EXAMPLE 2

The procedure of Example 1 was repeated with a developer solvent containing 50 wt % orange flower ether (CAS# 14576-08-0) and 50 wt % 2-ethyl-hexanol. The results are reported in Table 2.

As can be seen from the data, the developer solvent based on terpene ethers has similar performance when blended with other alcohols.

### EXAMPLE 3

The procedure of Example 1 was repeated with a developer solvent containing 50 wt % geranyl methyl ether and 50 wt % benzyl alcohol. The results are reported in Table 2.

As can be seen from the data, the developer solvent based on geranyl methyl ether, the methyl ether of an acyclic terpene, exhibited similar performance to that of a developer solvent containing methyl ethers of cyclic monoterpenes. Additional acyclic, monocyclic, and bicyclic terpene ethers were tested with similar performance.

### EXAMPLE 4

The procedure of Example 1 was repeated with a developer solvent containing 50 wt % p-menthane methyl ether and 50 wt % benzyl alcohol. The results are reported in Table 2.

As can be seen from the data, the developer solvent based on p-menthane methyl ether, the methyl ether of a saturated monocyclic terpene hydrocarbon, exhibits minimal swelling and fast dry time.

### EXAMPLE 5

The procedure of Example 1 was repeated with a developer solvent containing 20 wt % orange flower ether (CAS# 14576-08-0), 20 wt % benzyl alcohol, and 60 wt % isoparaffinic hydrocarbon (Isopar® L, mfg. by ExxonMobil). The results are reported in Table 2.

As can be seen from the data, the developer solvent based on terpene ethers exhibits reduced swelling and fast dry time even when blended with non-solvents such as isoparaffinic hydrocarbons. The addition of the non-solvent reduces the cost of the blend.

### EXAMPLE 6

A commercially available digital flexographic printing plate (0.067″ AFP® DHD, mfg. by Asahi) was first back-exposed using a UV light source in a commercial flexo plate exposure unit to form the cross-linked polymer floor of the printing plate. The top of the plate was exposed to the same UV light source through a negative mask created by ablating the non-transparent top mask layer in a Creo Digital Platesetter. The exposed plate was then developed by immersion with rotary brushing in 100 wt % orange flower ether (CAS# 14576-08-0). The development process was continued until the plate floor was reached. The time required to develop the plate to the floor is the “Wash Time” as reported in Table 2. The exposed plate thickness was measured after washout, and this data is reported as “Final Plate Thickness” in Table 2. The difference between initial thickness and final thickness is the “Plate Swell” as reported also in Table 2. The developed plate was then dried at 140° F. in a commercial flexo plate drying unit until it returned to its original thickness (0.067″), which is an indication that all absorbed solvent has been removed and the plate is dry. The time required to dry the plate is the “Dry Time” as reported in Table 2.

As can be seen from the data, the developer solvent based on terpene ethers exhibits minimal swelling and fast dry time, even on digital flexo plates. Co-solvents and non-solvents are not required for the development of digital plates (plates with an integral masking layer that do not require negatives during exposure), but can be optionally added to lower the cost or change the physical properties of the developer solvents without significantly impacting the performance.

### EXAMPLE 7 (COMPARATIVE)

The procedure of Example 1 was repeated with a developer solvent containing 50 wt % aromatic hydrocarbon solvent (Sure-Sol® 150, mfg. by Koch Industries) and 50 wt % benzyl alcohol. The results are reported in Table 2.

As can be seen from the data, the developer solvent based on aromatic hydrocarbons exhibit increased swelling during washout (even with shorter washout times), and much longer dry times. Similar results are obtained using developer solvents containing cyclic and acyclic unsaturated hydrocarbons such as d-limonene and mineral spirits.

TABLE 1
Developer Solvents Tested

| | Developer Solvent |
|---|---|
| Example 1 | 50 wt % orange flower ether (CAS# |
| | 14576-08-0) |
| | 50 wt % benzyl alcohol |
| Example 2 | 50 wt % orange flower ether (CAS# |
| | 14576-08-0) |
| | 50 wt % 2-ethyl-hexanol |
| Example 3 | 50 wt % geranyl methyl ether |
| | 50 wt % benzyl alcohol |
| Example 4 | 50 wt % p-menthane methyl ether |
| | 50 wt % benzyl alcohol |
| Example 5 | 20 wt % orange flower ether (CAS# |
| | 14576-08-0) |
| | 20 wt % benzyl alcohol |
| | 60 wt % Isopar ® L |
| Example 6 | 100 wt % orange flower ether (CAS# |
| | 14576-08-0) |
| | 50 wt % Sure-Sol ® 150 |
| Example 7 (Comparative) | 50 wt % benzyl alcohol |

TABLE 2
Solvent Performance Data

| | | Final Plate | | |
|---|---|---|---|---|
| | Wash Time | Thickness | Plate Swell | Dry Time |
| | (mins) | (inches) | (thousandths) | (minutes) |
| Example 1 | 11.1 | .0685 | 1.5 | 60 |
| Example 2 | 11.5 | .0687 | 1.7 | 72 |
| Example 3 | 12.8 | .0688 | 1.8 | 82 |
| Example 4 | 12.5 | .0687 | 1.7 | 69 |
| Example 5 | 25.2 | .0683 | 1.3 | 52 |
| Example 6 | 6.3 | .0698 | 2.8 | 65 |
| Example 7 | 5.5 | .0710 | 4.0 | >120 |
| (Comparative) | | | | |

While the invention has been described in detail and with reference to specific examples, it will be apparent to one skilled in the art that various changes, alternatives, and modifications can be made without departing from the spirit and scope of the present invention, which is to be defined by the following claims.

What is claimed is:

1. A photopolymer developing solution comprising at least one terpene ether.

2. The photopolymer developing solution of claim 1, wherein the terpene ether comprises a methyl ether.

3. The photopolymer developing solution of claim 1, wherein the terpene ether comprises an ethyl ether.

4. The photopolymer developing solution of claim 1, wherein the solution is substantially free of offending odors.

5. The photopolymer developing solution of claim 1, wherein the terpene ether is monocyclic.

6. The photopolymer developing solution of claim 1, wherein the terpene ether is selected from the group consisting of orange flower ether, terpinyl ethyl ether, p-cymenyl methyl ether, p-cymenyl-ethyl ether, fenchyl methyl ether, fenchyl ethyl ether, bornyl methyl ether, bornyl ethyl ether, carvyl methyl ether, carvyl ethyl ether, 3-allyloxy-2(10)-pinene, 2-(2-propynyloxy)-2(10)-pinene, 3-(methallyloxy)-2(10)-pinene, p-menthane methyl ether, p-menthane ethyl ether, geranyl methyl ether, geranyl ethyl ether, linalyl methyl ether, linalyl ethyl ether and combinations thereof.

7. The photopolymer developing solution of claim 1, wherein the terpene ether is an orange flower ether.

8. The photopolymer developing solution of claim 1, further comprising at least one co-solvent.

9. The photopolymer developing solution of claim 8, wherein the co-solvent is selected from the group consisting of benzyl alcohol, ethanol, methanol, propanol, alpha terpineol, dipropylene glycol methyl ether, 2-butoxyethanol, isopropyl alcohol, 2(2-butoxyethoxy)ethanol and mixtures thereof.

10. The photopolymer developing solution of claim 8, wherein the co-solvent is a benzyl alcohol.

11. The photopolymer developing solution of claim 1, wherein the solution includes an orange flower ether and a benzyl alcohol.

12. The photopolymer developing solution of claim 1, further including at least one non-solvent.

13. The photopolymer developing solution of claim 12, wherein the non-solvent is selected from the group consisting of mineral spirits, aliphatic petroleum distillates, naphthas, paraffinic solvents, hydrotreated petroleum distillates, mineral oil, ligroin, decane, octane, hexane and mixtures thereof.

14. The photopolymer developing solution of claim 1, wherein the solution has a flash point greater than 140° F.

15. A photopolymer developing solution comprising a solvent and at least one terpene ether selected from the group consisting essentially of orange flower ether, terpinyl ethyl ether, p-cymenyl methyl ether, p-cymenyl-ethyl ether, fenchyl methyl ether, fenchyl ethyl ether, bornyl methyl ether, bornyl ethyl ether, carvyl methyl ether, carvyl ethyl ether, 3-allyloxy-2(10)-pinene, 2-(2-propynyloxy)-2(10)-pinene, 3-(methallyloxy)-2(10)-pinene, p-menthane methyl ether, p-menthane ethyl ether, geranyl methyl ether, geranyl ethyl ether, linalyl methyl ether, linalyl ethyl ether and combinations thereof.

16. A photopolymer developing solution comprising an orange flower ether and a benzyl alcohol.

17. A method for developing photopolymer printing plates comprising:
washing an exposed photopolymer printing plate with a developing solution including at least one terpene ether; and
drying the photopolymer printing plate.

18. The method of claim 17, further including exposing a backside of the photopolymer printing plate to a radiation source for cross-linking a polymer and exposing a topside of the photopolymer printing plate to the radiation source through a negative mask to produce the exposed photopolymer printing plate.

19. The method of claim 17, wherein the terpene ether comprises a methyl ether.

20. The method of claim 17, wherein the terpene ether comprises an ethyl ether.

21. The method of claim 17, wherein the terpene is monocyclic.

22. The method of claim 17, wherein the terpene ether is selected from the group consisting of orange flower ether, terpinyl ethyl ether, p-cymenyl methyl ether, p-cymenyl-ethyl ether, fenchyl methyl ether, fenchyl ethyl ether, bornyl methyl ether, bornyl ethyl ether, carvyl methyl ether, carvyl ethyl ether, 3-allyloxy-2(10)-pinene, 2-(2-propynyloxy)-2(10)-pinene, 3-(methallyloxy)-2(10)-pinene, p-menthane methyl ether, p-menthane ethyl ether, geranyl methyl ether, geranyl ethyl ether, linalyl methyl ether, linalyl ethyl ether and combinations thereof.

23. The method of claim 17, wherein the terpene ether is an orange flower ether.

24. The method of claim 17, wherein the developing solution further includes at least one co-solvent.

25. The method of claim 17, wherein the developing solution further includes at least one non-solvent.
